(19) United States
(12) Patent Application Publication
(10) Pub. No.: US 2026/0141490 A1
(43) Pub. Date: May 21, 2026

(54) LATENT PATCHED DIFFUSION MODELS TO SYNTHESIZE MEGA HIGH RESOLUTION IMAGES

(71) Applicant: Samsung Electronics Co., Ltd., Suwon-si (KR)

(72) Inventors: Weiyun Jiang, Houston, TX (US); Devendra Kumar Jangid, Plano, TX (US); Pavan C. Madhusudanarao, The Colony, TX (US); John Seokjun Lee, Allen, TX (US); Hamid Rahim Sheikh, Allen, TX (US)

(21) Appl. No.: 18/953,487

(22) Filed: Nov. 20, 2024

(51) Int. Cl. G06T 5/70; G06T 5/60

(52) U.S. Cl. CPC G06T 5/70; G06T 5/60; G06T 2207/20084

(57) ABSTRACT

A method includes obtaining at least one input image and processing the at least one input image using an encoder model. The method also includes generating an output based on the processing of the at least one input image using the encoder model. The method also includes providing the output to a diffusion model and generating, using the diffusion model and based on the output, at least one image in a latent space. The method also includes outputting a final image result based on the at least one image in the latent space.

### TECHNICAL FIELD

This disclosure relates generally to image processing and machine learning systems. More specifically, this disclosure relates to latent patched diffusion models to synthesize mega high resolution images.

### BACKGROUND

Recent advancements in diffusion models have established them as superior for image synthesis compared to generative adversarial networks. However, diffusion models face challenges in training and inference for mega high resolution images due to inefficiencies in pixel space optimization, multi-step denoising, and limitations in contrastive language-image pretraining initialization. Current methods, such as super-resolution techniques and patched-based synthesis, often result in suboptimal performance due to computational inefficiencies.

### SUMMARY

This disclosure relates to latent patched diffusion models to synthesize mega high resolution images.

In one example, a method includes obtaining at least one input image. The method also includes processing the at least one input image using an encoder model. The method also includes generating an output based on the processing of the at least one input image using the encoder model. The method also includes providing the output to a diffusion model. The method also includes generating, using the diffusion model and based on the output, at least one image in a latent space. The method also includes outputting a final image result based on the at least one image in the latent space.

In another example, an electronic device includes at least one processing device. The at least one processing device is configured to obtain at least one input image. The at least one processing device is also configured to process the at least one input image using an encoder model. The at least one processing device is also configured to generate an output based on the processing of the at least one input image using the encoder model. The at least one processing device is also configured to provide the output to a diffusion model. The at least one processing device is also configured to generate, using the diffusion model and based on the output, at least one image in a latent space. The at least one processing device is also configured to output a final image result based on the at least one image in the latent space.

In another example, a non-transitory machine readable medium includes instructions that, when executed by at least one processor, cause an electronic device to obtain at least one input image. The non-transitory machine readable medium also includes instructions that, when executed by the at least one processor, cause the electronic device to process the at least one input image using an encoder model. The non-transitory machine readable medium also includes instructions that, when executed by the at least one processor, cause the electronic device to generate an output based on the processing of the at least one input image using the encoder model. The non-transitory machine readable medium also includes instructions that, when executed by the at least one processor, cause the electronic device to provide the output to a diffusion model. The non-transitory machine readable medium also includes instructions that, when executed by the at least one processor, cause the electronic device to generate, using the diffusion model and based on the output, at least one image in a latent space. The non-transitory machine readable medium also includes instructions that, when executed by the at least one processor, cause the electronic device to output a final image result based on the at least one image in the latent space.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example image synthesis process using a latent space patched-based diffusion model in accordance with this disclosure;

FIG. 3 illustrates an example encoder architecture for a latent space patched-based diffusion model in accordance with this disclosure;

FIG. 4 illustrates an example image synthesis method in accordance with this disclosure;

FIG. 5 illustrates an example image synthesis method using a latent space patched-based diffusion model in accordance with this disclosure;

FIG. 6 illustrates an example image synthesis process using a multi-level encoder model in accordance with this disclosure;

FIG. 7 illustrates an example multi-level encoder architecture in accordance with this disclosure; and

FIG. 8 illustrates an example image synthesis method using a multi-level encoder model in accordance with this disclosure.

### DETAILED DESCRIPTION

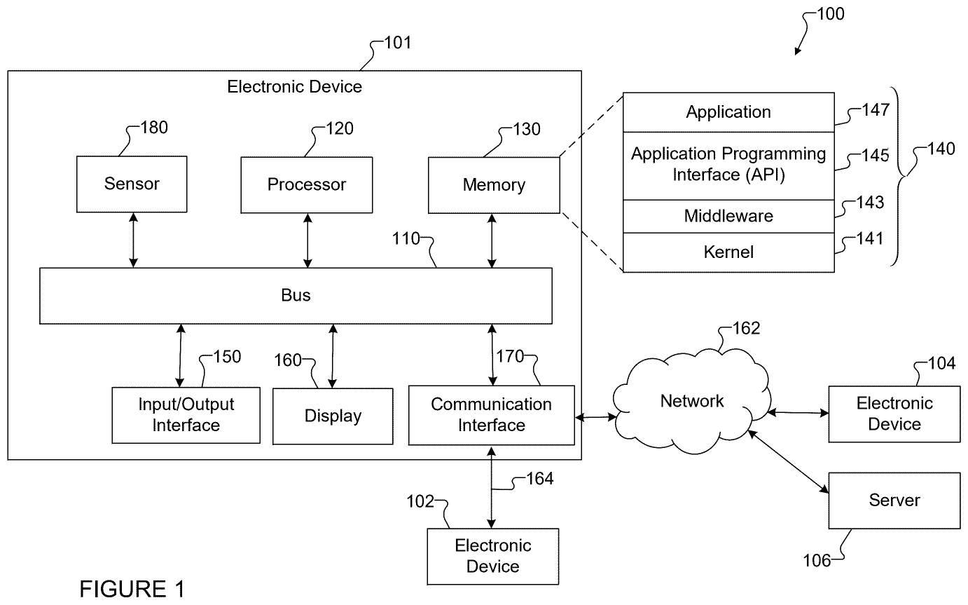

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, recent advancements in diffusion models have established them as superior for image synthesis compared to generative adversarial networks (GANs). However, diffusion models face challenges in training and inference for mega high resolution images due to inefficiencies in pixel space optimization, multi-step denoising, and limitations in contrastive language-image pretraining (CLIP) initialization. Current methods, such as super-resolution techniques and patched-based synthesis, often result in suboptimal performance due to computational inefficiencies.

Existing diffusion models use a single training step in which a patch is randomly cropped from ground truth images, noise with random variances is added to the ground truth patch, and a denoising model is used to learn to predict the amount of noise added to the ground truth patches. Overall, this existing process will learn the distribution of training datasets. Once trained, existing diffusion models are provided with a noise patch, and, in each step, the diffusion model denoises noisy patches. A small amount of noise is then added to the denoised output at each step for creating diversity in the generated output. In the final steps, all denoised patches are combined to form the final image. These existing approaches have several drawbacks. For example, while a high-resolution image can be generated without boundary artifacts or less artifacts using an overlapping of patches during inference, this overlapping method increases the number of patches which leads to an increase in inference time by the diffusion model. In addition to increased inference times, the result is limited by the number overlapping pixels instead of having all neighboring patch information.

This disclosure provides for techniques that bypass the inefficiencies of pixel space optimization and address the out-of-distribution issues for CLIP, enabling synthesis of low-resolution patches inside high-resolution images via computational efficient diffusion models. By leveraging a latent space patched diffusion methodology, this disclosure provides for a diffusion model to achieve around a 7× speed increase in image synthesis and a 12× speed improvement in training for generating high-resolution images (e.g., 1024×1024 or 2048×2048 images) as compared to existing methods. Various embodiments of this disclosure provide for a latent space patch-based diffusion model that utilizes a compressed latent space image (e.g., an 8× compressed latent space image) to generate high quality mega high-resolution (e.g., 1024×1024 or 2048×2048) images unconditionally. Various embodiments of this disclosure also provide for a multi-level global encoder that ensures global consistency for each patch through various actions including utilizing ground truth whole images in the latent space as inputs, producing corresponding semantic code for each GT image, optimizing for the best semantic code that describes the content of each GT image, eliminating the limitations of the previous CLIP initialization, and addressing the out-of-distribution issue for CLIP. Images produced using the various embodiments of this disclosure have been found to provide high quality image details, including in areas of images having fine details such as skin wrinkles and hair.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. Also note that while some of the embodiments discussed below are described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to latent patched diffusion models to synthesize mega high resolution images.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to latent patched diffusion models to synthesize mega high resolution images. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first external electronic device 102, a second external electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to latent patched diffusion models to synthesize mega high resolution images.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

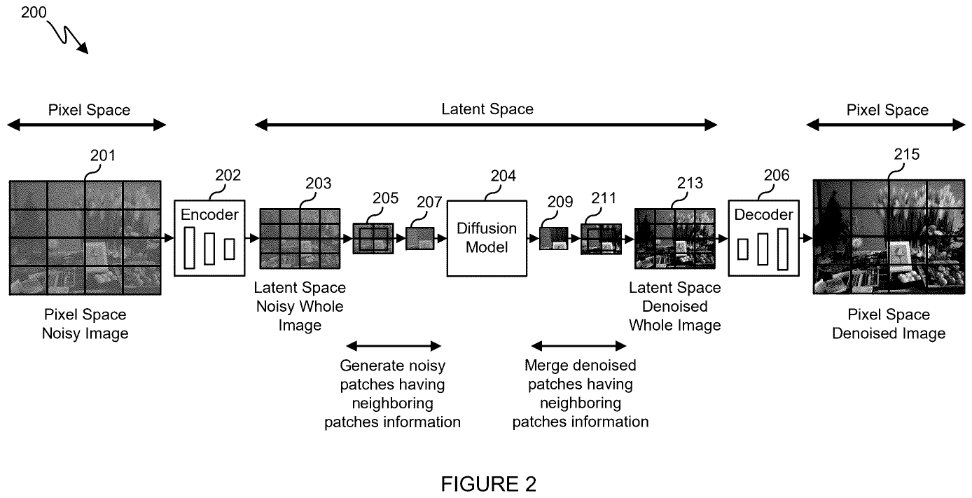

FIG. 2 illustrates an example image synthesis process 200 using a latent space patched-based diffusion model in accordance with this disclosure. For ease of explanation, the process 200 shown in FIG. 2 is described as being implemented on or supported by the electronic device 101 in the network configuration 100 of FIG. 1. However, the process 200 shown in FIG. 2 could be used with any other suitable device(s) and in any other suitable system(s), such as when the process 200 is implemented on or supported by the server 106.

As shown in FIG. 2, a pixel space noisy image 201 is provided as input to an overall model architecture that includes an encoder model 202, a diffusion model 204, and a decoder model 206. In various embodiments, the encoder model 202 and the decoder model 206 can be pretrained. In various embodiments, the pixel space noisy image 201 is an image in a pixel-based coordinate space, and can be of a high resolution, such as a resolution of 2048×2048×3. In various embodiments, the diffusion model can include a UNET architecture (e.g., a U-shaped convolutional neural network architecture), but could be comprised of other architecture types as desired or appropriate.

As also shown in FIG. 2, the encoder model 202 encodes the pixel space noisy image 201 into a latent space to create a latent space noisy whole image 203. The latent space noisy whole image 203 can be of a different resolution than the pixel space noisy image 201, such as a resolution of 256×256×4. The latent space, in various embodiments, is a lower-dimensional representation of high-dimensional data corresponding to pixel space noisy image 201 input data that captures the underlying factors explain the data's variability.

The latent space noisy whole image 203 is divided into latent space noisy patches that have neighboring patches information. For example, at least one latent space noisy neighboring patches embedding 205 is created from the latent space noisy whole image 203, and at least one latent space noisy patch embedding 207 is created from the latent space noisy neighboring patches embedding 205. The latent space noisy neighboring patches embedding 205 the latent space noisy patch embedding 207 have different resolutions. For instance, the latent space noisy neighboring patches embedding 205 can have a resolution of 128×128×4, and the latent space noisy patch embedding 207 can have a resolution of 64×64×4.

The diffusion model 204 receives the at least one latent space noisy patch embedding 207 and denoises the noisy patches in the latent space. Denoised patches in the latent space are reassembled/merged. For example, as shown in FIG. 2, at least one latent space denoised patch embedding 209 is output by the diffusion model 204, and at least one latent space denoised neighboring patches embedding 211 is generated using the at least one latent space noisy patch embedding 207. As shown in FIG. 2, the at least one latent space denoised patch embedding 209 has a resolution corresponding to the at least one latent space noisy patch embedding 207 (e.g., 64×64×4), and the at least one latent space denoised neighboring patches embedding 211 has a resolution corresponding to the at least one latent space noisy neighboring patches embedding 205 (e.g., 128×128×4).

Using the at least one latent space denoised patch embedding 209 and the at least one latent space denoised neighboring patches embedding 211, a latent space denoised whole image 213 is reassembled. The latent space denoised whole image 213 has a resolution corresponding to the latent space noisy whole image 203 (e.g., 256×256×4). The decoder model 206 takes as input the latent space denoised whole image 213 and decodes the latent space denoised whole image 213 back into the pixel space to provide a pixel space denoised image 215 as a final output image. The process 200 thus provides a latent space patched-based diffusion model that utilizes compressed latent space images (e.g., 8× compressed) to generate high quality mega high resolution (e.g., 2048×2048) images unconditionally.

Although FIG. 2 illustrates one example of an image synthesis process 200 using a latent space patched-based diffusion model, various changes may be made to FIG. 2. For example, various components and functions in FIG. 2 may be combined, further subdivided, replicated, or rearranged according to particular needs. Also, one or more additional components and functions may be included if needed or desired. Additionally, while shown as a series of steps, various steps in FIG. 2 could overlap, occur in parallel, occur in a different order, or occur any number of times (including zero times).

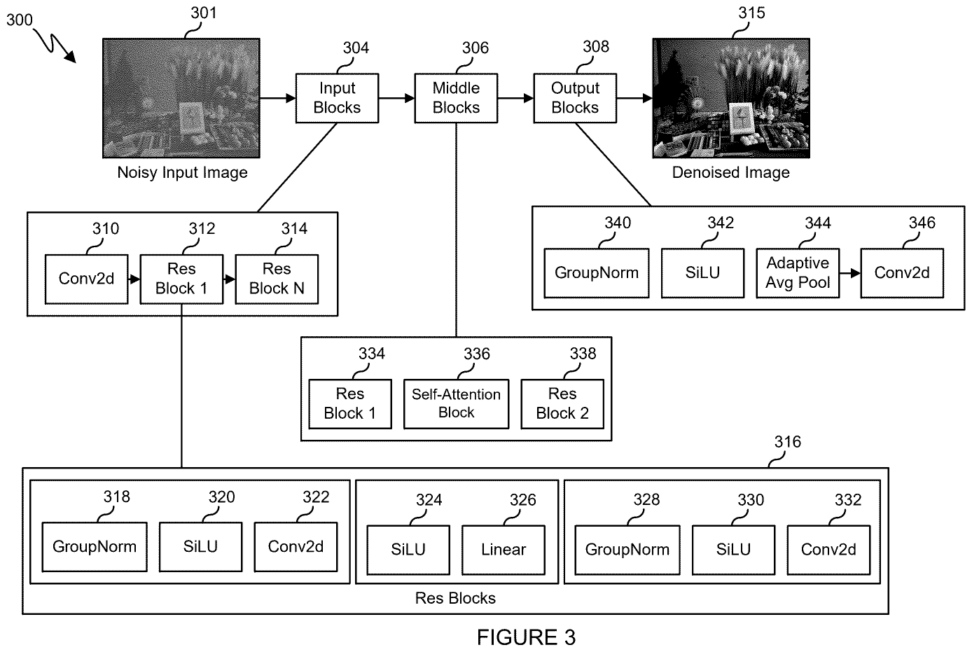

FIG. 3 illustrates an example encoder architecture 300 for a latent space patched-based diffusion model in accordance with this disclosure. For ease of explanation, the architecture 300 shown in FIG. 3 is described as being implemented on or supported by the electronic device 101 in the network configuration 100 of FIG. 1. However, the architecture 300 shown in FIG. 3 could be used with any other suitable device(s) and in any other suitable system(s), such as when the architecture 300 is implemented on or supported by the server 106. In various embodiments, the architecture 300 can be used to perform the process 200 described with respect to FIG. 2.

As shown in FIG. 3, the architecture 300 includes input blocks 304, middle blocks 306, and output blocks 308. A noisy input image 301, which can correspond to the pixel space noisy image 201 of FIG. 2, is provided to input blocks 304 of the architecture 300. The input blocks 304 can include a two-dimensional convolutional operation block 310 and one or more residual blocks, including a first residual block 312 and an N residual block 314. For instance, if the images are to be compressed by 8×, N is equal to 8.

As shown in FIG. 3, the residual blocks, including the first residual block 312 and the N residual block 314, can include various sub-operation blocks 316. For example, as shown in FIG. 3, the sub-operation blocks 316 can include a group normalization (GroupNorm) operation 318, followed by a sigmoid linear units (SiLU) operation 320, and a two-dimensional convolutional operation 322, followed by another SiLU operation 324 and a linear operation 326, followed by another GroupNorm operation 328, another SiLU operation 330, and another two-dimensional convolutional operation 332.

The middle blocks 306 of the architecture 300 can include a first residual block 334, a self-attention block 336, and a second residual block 338. In various embodiments, the first residual block 334 and the second residual block 338 can include the same or similar sub-operations as the sub-operation blocks 316. The output blocks 308 can include a GroupNorm operation 340, a SiLU operation 342, an adaptive averaging pool operation 344, and a two-dimensional convolutional operation 346.

Although FIG. 3 illustrates one example of an encoder architecture 300 for a latent space patched-based diffusion model, various changes may be made to FIG. 3. For example, various components and functions in FIG. 3 may be combined, further subdivided, replicated, or rearranged according to particular needs. Also, one or more additional components and functions may be included if needed or desired.

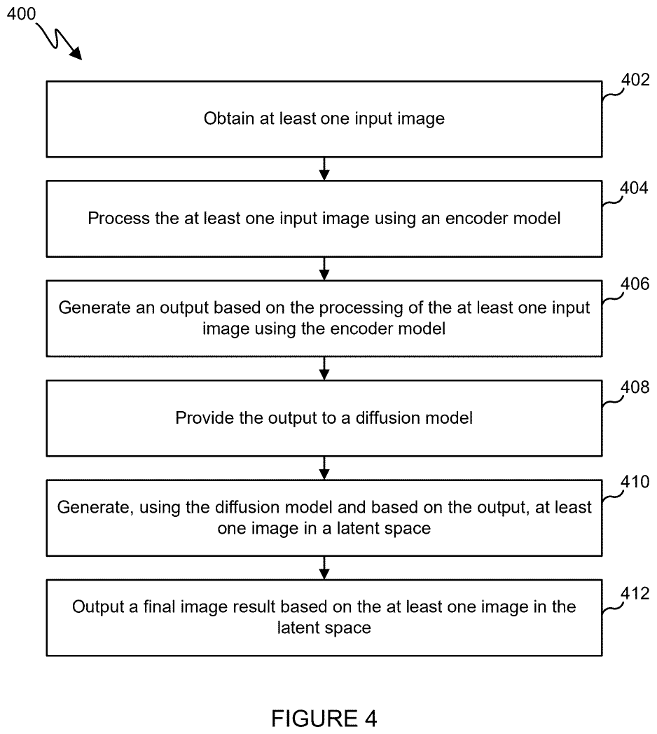

FIG. 4 illustrates an example image synthesis method 400 in accordance with this disclosure. For ease of explanation, the method 400 shown in FIG. 4 is described as being performed using the electronic device 101 in the network configuration 100 of FIG. 1. However, the method 400 could be performed using any other suitable device(s), such as the server 106, and in any other suitable system(s). The method 400 can be used, for example, as or as part of the process 200 or the process 600 of this disclosure.

At step 402, at least one input image is obtained. This can include the processor 120 of the electronic device 101 retrieving an input image, such as the pixel space noisy image 201 or the ground truth latent space images 601 of this disclosure. At step 404, the at least one input image is processed using an encoder model. This can include the processor 120 of the electronic device 101 providing the input image to the encoder model and executing the encoder model, such as the encoder model 202 or the multi-level encoder model 602 of this disclosure.

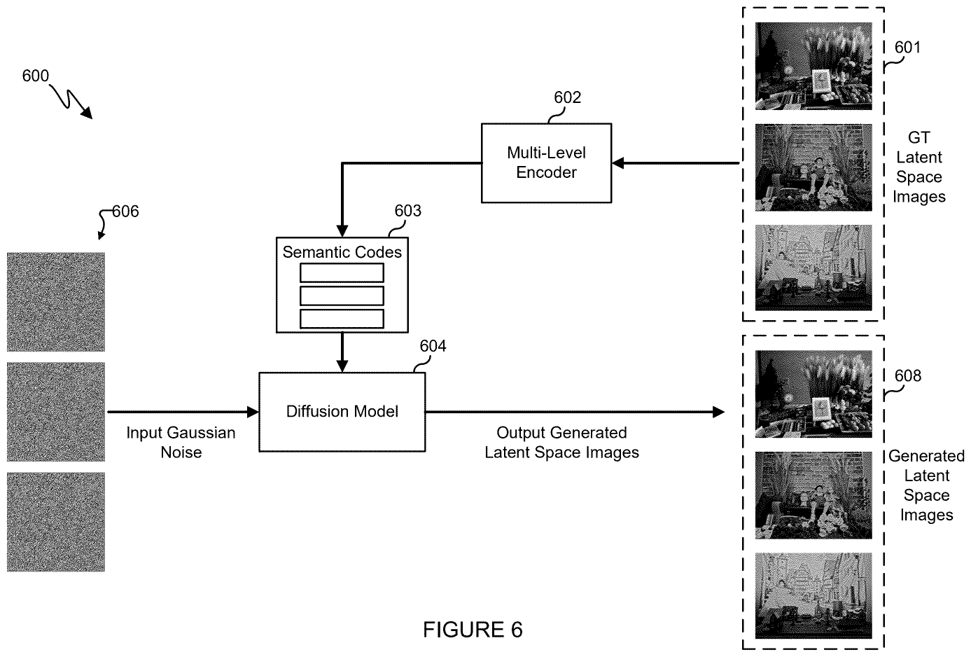

At step 406, an output is generated based on the processing of the at least one input image using the encoder model. As described in this disclosure, the output can be, for example, at least one latent space image (or noisy patch embeddings thereof) as described for example with respect to FIG. 2, or semantic code as described for example with respect to FIG. 6. At step 408, the output is provided to a diffusion model, such as the diffusion model 204 or the diffusion model 604 of this disclosure. At step 410, at least one image in a latent space is generated using the diffusion model and based on the output provided to the diffusion model at step 408. This can include, for example, the processor 120 executing the diffusion model 204 to generate the pixel space denoised image 215, or executing the diffusion model 604 to generate at least one latent space output image 608.

At step 412, a final image result is output based on the at least one image in the latent space generated at step 410. This can include, for example, the processor 120 causing the final image result to be stored at a storage location of the electronic device 101 or another device, such as the server 106, or displaying the final image result on a display screen, such as the display 160.

Although FIG. 4 illustrates one example of an image synthesis method 400, various changes may be made to FIG. 4. For example, while shown as a series of steps, various steps in FIG. 4 could overlap, occur in parallel, occur in a different order, or occur any number of times (including zero times).

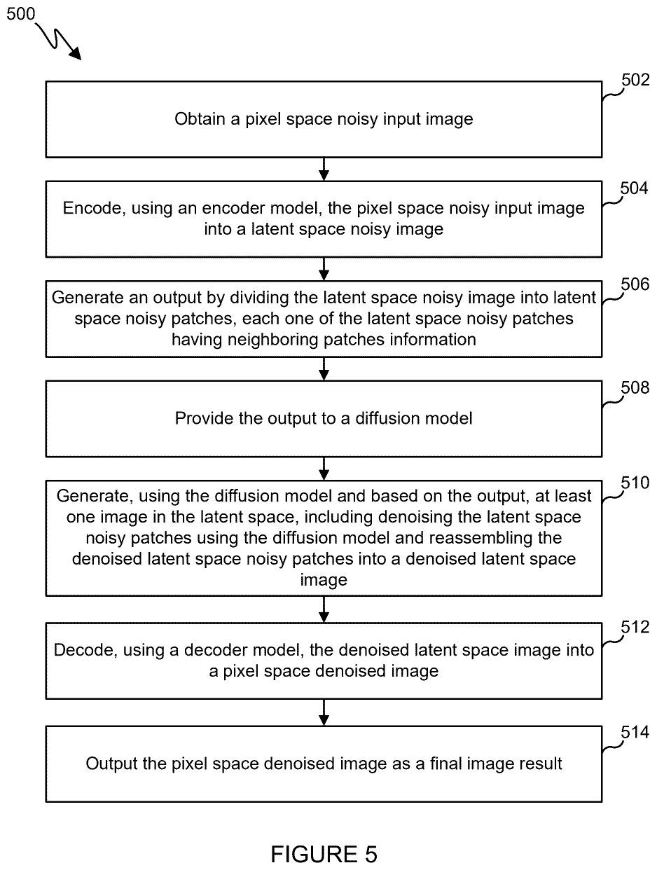

FIG. 5 illustrates an example image synthesis method 500 using a latent space patched-based diffusion model in accordance with this disclosure. For ease of explanation, the method 500 shown in FIG. 5 is described as being performed using the electronic device 101 in the network configuration 100 of FIG. 1. However, the method 500 could be performed using any other suitable device(s), such as the server 106, and in any other suitable system(s). The method 500 can be used, for example, as or as part of the process 200 of this disclosure.

At step 502, a pixel space noisy input image is obtained. This can include the processor 120 of the electronic device 101 retrieving a pixel space noisy input image, such as the pixel space noisy image 201 of this disclosure. At step 504, the pixel space noisy input image is encoded into a latent space noisy image using an encoder model. This can include the processor 120 of the electronic device 101 providing the pixel space noisy input image to the encoder model and executing the encoder model, such as the encoder model 202 of this disclosure, to generate the latent space noisy whole image 203.

At step 506, an output is generated by dividing the latent space noisy image into latent space noisy patches, each one of the latent space noisy patches having neighboring patches information. As described in this disclosure, the output can be, for example, noisy patch embeddings of the at least one latent space noisy whole image 203, as described for example with respect to FIG. 2. At step 508, the output is provided to a diffusion model, such as the diffusion model 204 of this disclosure. At step 510, at least one image in a latent space is generated using the diffusion model and based on the output provided to the diffusion model at step 508. Step 510 can include denoising the latent space noisy patches using the diffusion model and reassembling the denoised latent space noisy patches into a denoised latent space image.

At step 512, the denoised latent space image is decoded, using a decoder, into a pixel space denoised image. This can include the processor 120 executing the decoder model 206 of FIG. 2. At step 514, the pixel space denoised image is output as a final image result. This can include, for example, the processor 120 causing the pixel space denoised image to be stored at a storage location of the electronic device 101 or another device, such as the server 106, or displaying the pixel space denoised image on a display screen, such as the display 160.

Although FIG. 5 illustrates one example of an image synthesis method 500 using a latent space patched-based diffusion model, various changes may be made to FIG. 5. For example, while shown as a series of steps, various steps in FIG. 5 could overlap, occur in parallel, occur in a different order, or occur any number of times (including zero times).

FIG. 6 illustrates an example image synthesis process 600 using a multi-level encoder model in accordance with this disclosure. For ease of explanation, the process 600 shown in FIG. 6 is described as being implemented on or supported by the electronic device 101 in the network configuration 100 of FIG. 1. However, the process 600 shown in FIG. 6 could be used with any other suitable device(s) and in any other suitable system(s), such as when the process 600 is implemented on or supported by the server 106.

As shown in FIG. 6, the process 600 includes using a multi-level encoder model 602, which can be a global encoder to ensure global consistency for each image patch. The multi-level encoder model 602 utilizes ground truth (GT) whole images 601 in the latent space as inputs to produce corresponding semantic code for each GT image 601, and optimizes for the best semantic code that describes the content of each GT image 601.

The semantic codes corresponding to the GT latent space images 601 output by the multi-level encoder model 602 are provided to a diffusion model 604. The diffusion model 604 also takes as input gaussian noise 606. Based on the semantic codes 603 and the gaussian noise 606, the diffusion model outputs generated latent space images 608. The process 600 reduces or eliminates the limitations of original CLIP initialization and addresses the out-of-distribution issue for CLIP. That is, CLIP is pre-trained network on a text-image dataset that generates semantic codes that have semantic level information, but CLIP will not work well if images were not part of distribution of training datasets. The multi-level encoder model 602 of this disclosure, however, takes images and focuses on multi-scale level information of the images to produce semantic codes 603 that can be used by the diffusion model 604 to produce accurate image synthesis results.

Although FIG. 6 illustrates one example of an image synthesis process 600 using a multi-level encoder model, various changes may be made to FIG. 6. For example, various components and functions in FIG. 6 may be combined, further subdivided, replicated, or rearranged according to particular needs. Also, one or more additional components and functions may be included if needed or desired. Additionally, while shown as a series of steps, various steps in FIG. 6 could overlap, occur in parallel, occur in a different order, or occur any number of times (including zero times).

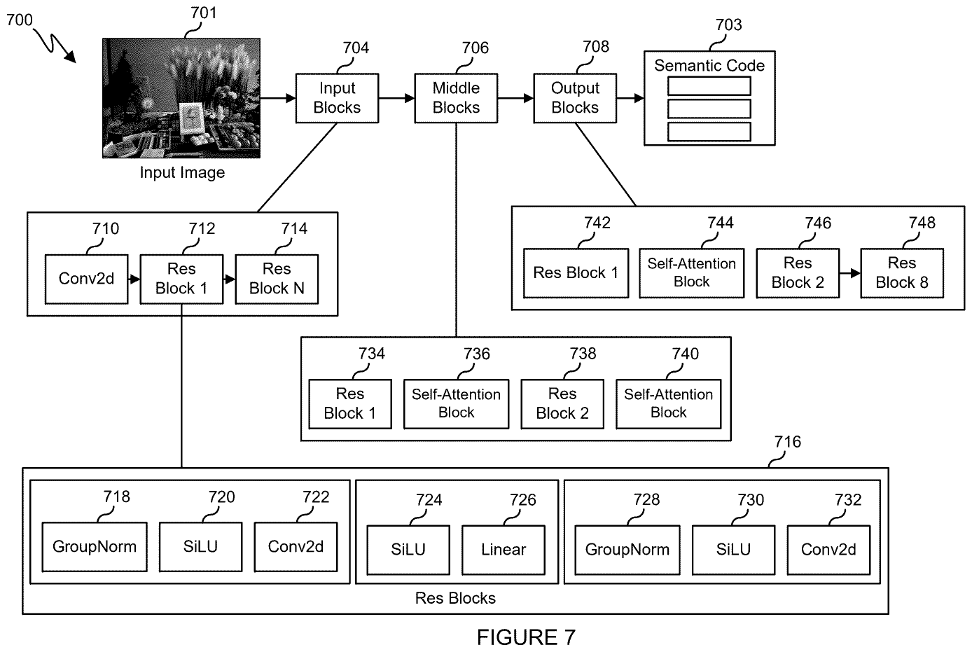

FIG. 7 illustrates an example multi-level encoder architecture 700 in accordance with this disclosure. For ease of explanation, the architecture 700 shown in FIG. 7 is described as being implemented on or supported by the electronic device 101 in the network configuration 100 of FIG. 1. However, the architecture 700 shown in FIG. 7 could be used with any other suitable device(s) and in any other suitable system(s), such as when the architecture 700 is implemented on or supported by the server 106. In various embodiments, the architecture 700 can be used to perform the process 600 described with respect to FIG. 6.

As shown in FIG. 7, the architecture 700 includes input blocks 704, middle blocks 706, and output blocks 708. A noisy input image 701, which can correspond to the GT latent space images 601 of FIG. 6, is provided to input blocks 704 of the architecture 700. The input blocks 704 can include a two-dimensional convolutional operation block 710 and one or more residual blocks, including a first residual block 712 and an N residual block 714. As also shown in FIG. 7, the residual blocks, including the first residual block 712 and the N residual block 714, can include various sub-operation blocks 716. For example, as shown in FIG. 7, the sub-operation blocks 716 can include a GroupNorm operation 718, followed by a SiLU operation 720, and a two-dimensional convolutional operation 722, followed by another SiLU operation 724 and a linear operation 726, followed by another GroupNorm operation 728, another SiLU operation 730, and another two-dimensional convolutional operation 732.

The middle blocks 706 of the architecture 700 can include a first residual block 734, a self-attention block 736, a second residual block 738, and a second self-attention block 740. In various embodiments, the first residual block 734 and the second residual block 738 can include the same or similar sub-operations as the sub-operation blocks 716. The output blocks 708 can include a first residual block 742 and a self-attention block 744, followed by additional residual blocks including a second residual block 746 and an N residual block 748. In various embodiments, the residual blocks of the output blocks 708, including the first residual block 742, the second residual block 746, and the N residual block 748, can include the same or similar sub-operations as the sub-operation blocks 716.

Although FIG. 7 illustrates one example of a multi-level encoder architecture 700, various changes may be made to FIG. 7. For example, various components and functions in FIG. 7 may be combined, further subdivided, replicated, or rearranged according to particular needs. Also, one or more additional components and functions may be included if needed or desired.

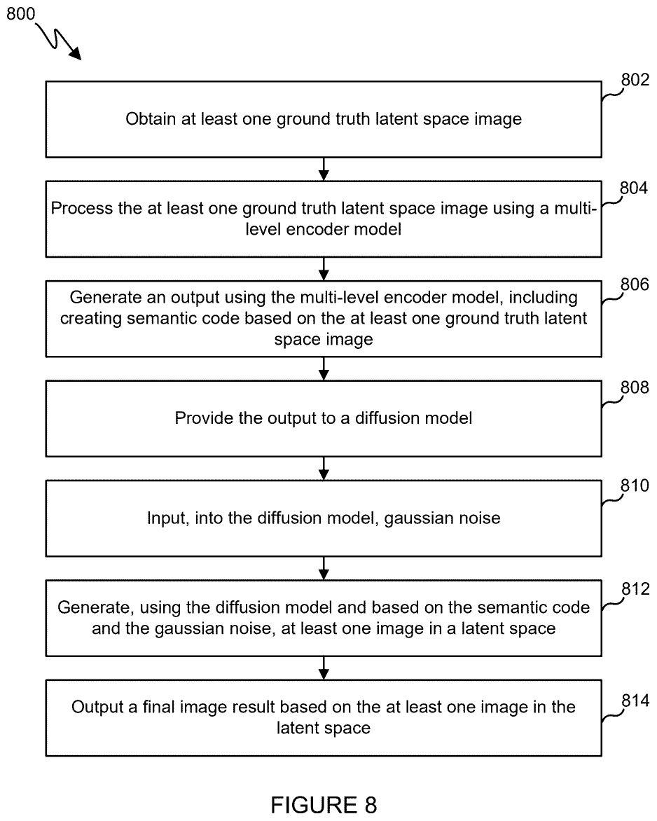

FIG. 8 illustrates an example image synthesis method 800 using a multi-level encoder model in accordance with this disclosure. For ease of explanation, the method 800 shown in FIG. 8 is described as being performed using the electronic device 101 in the network configuration 100 of FIG. 1. However, the method 800 could be performed using any other suitable device(s), such as the server 106, and in any other suitable system(s). The method 800 can be used, for example, as or as part of the process 600 of this disclosure.

At step 802, at least one ground truth latent space image is obtained. This can include the processor 120 of the electronic device 101 retrieving an input image, such as the ground truth latent space images 601 of this disclosure. At step 804, the at least one ground truth latent space image is processed using a multi-level encoder model. This can include the processor 120 of the electronic device 101 providing the ground truth latent space image to the multi-level encoder model and executing the multi-level encoder model, such as the multi-level encoder model 602 of this disclosure.

At step 806, an output is generated using the multi-level encoder model, including creating semantic code based on the at least one ground truth latent space image. As described in this disclosure, the output can be, for example, the semantic code 603 as described for example with respect to FIG. 6. At step 808, the output is provided to a diffusion model, such as the diffusion model 604 of this disclosure. At step 810, gaussian noise is input into the diffusion model. At step 812, at least one image in the latent space is generated using the diffusion model and based on the semantic code and gaussian noise input into the diffusion model at steps 808 and 810. This can include, for example, the processor 120 executing the diffusion model 604 to generate the at least one latent space output image 608.

At step 814, a final image result is output based on the at least one image in the latent space generated at step 812. This can include, for example, the processor 120 causing the final image result to be stored at a storage location of the electronic device 101 or another device, such as the server 106, or displaying the final image result on a display screen, such as the display 160.

Although FIG. 8 illustrates one example of an image synthesis method 800 using a multi-level encoder model, various changes may be made to FIG. 8. For example, while shown as a series of steps, various steps in FIG. 8 could overlap, occur in parallel, occur in a different order, or occur any number of times (including zero times).

It should be noted that the functions described above can be implemented in an electronic device 101, 102, 104, server 106, or other device(s) in any suitable manner. For example, in some embodiments, at least some of the functions described above can be implemented or supported using one or more software applications or other software instructions that are executed by the processor 120 of the electronic device 101, 102, 104, server 106, or other device(s). In other embodiments, at least some of the functions described above can be implemented or supported using dedicated hardware components. In general, the functions described above can be performed using any suitable hardware or any suitable combination of hardware and software/firmware instructions. Also, the functions described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
obtaining at least one input image;
processing the at least one input image using an encoder model;
generating an output based on the processing of the at least one input image using the encoder model;
providing the output to a diffusion model;
generating, using the diffusion model and based on the output, at least one image in a latent space; and
outputting a final image result based on the at least one image in the latent space.

2. The method of claim 1, wherein:
the at least one input image includes a pixel space noisy input image; and
processing the at least one input image using the encoder model includes encoding the pixel space noisy input image into a latent space noisy image.

3. The method of claim 2, wherein generating the output based on the processing of the at least one input image using the encoder model includes dividing the latent space noisy image into latent space noisy patches, wherein each one of the latent space noisy patches has neighboring patches information.

4. The method of claim 3, wherein generating, using the diffusion model and based on the output, the at least one image in the latent space includes:
denoising the latent space noisy patches using the diffusion model; and
reassembling the denoised latent space noisy patches into a denoised latent space image.

5. The method of claim 4, wherein outputting the final image result based on the at least one image in the latent space includes:
decoding, using a decoder model, the denoised latent space image into a pixel space denoised image; and
outputting the pixel space denoised image as the final image result.

6. The method of claim 1, wherein:
the at least one input image includes at least one ground truth latent space image;
the encoder model is a multi-level encoder model; and
generating the output based on the processing of the at least one input image using the encoder model includes creating, using the multi-level encoder model, semantic code based on the at least one ground truth latent space image.

7. The method of claim 6, wherein generating, using the diffusion model and based on the output, the at least one image in the latent space includes:
inputting, into the diffusion model, the semantic code and gaussian noise; and
generating, using the diffusion model and based on the semantic code and the gaussian noise, the at least one image in the latent space.

8. An electronic device comprising:
at least one processing device configured to:
obtain at least one input image;
process the at least one input image using an encoder model;
generate an output based on the processing of the at least one input image using the encoder model;
provide the output to a diffusion model;
generate, using the diffusion model and based on the output, at least one image in a latent space; and
output a final image result based on the at least one image in the latent space.

9. The electronic device of claim 8, wherein:
the at least one input image includes a pixel space noisy input image; and
to process the at least one input image using the encoder model, the at least one processing device is configured to encode the pixel space noisy input image into a latent space noisy image.

10. The electronic device of claim 9, wherein, to generate the output based on the processing of the at least one input image using the encoder model, the at least one processing device is configured to divide the latent space noisy image into latent space noisy patches, wherein each one of the latent space noisy patches has neighboring patches information.

11. The electronic device of claim 10, wherein, to generate, using the diffusion model and based on the output, the at least one image in the latent space, the at least one processing device is configured to:
denoise the latent space noisy patches using the diffusion model; and
reassemble the denoised latent space noisy patches into a denoised latent space image.

12. The electronic device of claim 11, wherein, to output the final image result based on the at least one image in the latent space, the at least one processing device is configured to:
decode, using a decoder model, the denoised latent space image into a pixel space denoised image; and
output the pixel space denoised image as the final image result.

13. The electronic device of claim 8, wherein:
the at least one input image includes at least one ground truth latent space image;
the encoder model is a multi-level encoder model; and
to generate the output based on the processing of the at least one input image using the encoder model, the at least one processing device is configured to create, using the multi-level encoder model, semantic code based on the at least one ground truth latent space image.

14. The electronic device of claim 13, wherein, to generate, using the diffusion model and based on the output, the at least one image in the latent space, the at least one processing device is configured to:
input, into the diffusion model, the semantic code and gaussian noise; and
generate, using the diffusion model and based on the semantic code and the gaussian noise, the at least one image in the latent space.

15. A non-transitory machine readable medium comprising instructions that, when executed by at least one processor, cause an electronic device to:
obtain at least one input image;
process the at least one input image using an encoder model;
generate an output based on the processing of the at least one input image using the encoder model;
provide the output to a diffusion model;
generate, using the diffusion model and based on the output, at least one image in a latent space; and
output a final image result based on the at least one image in the latent space.

16. The non-transitory machine readable medium of claim 15, wherein:
the at least one input image includes a pixel space noisy input image; and
the instructions that when executed by the at least one processor cause the electronic device to process the at least one input image using the encoder model comprise instructions that when executed by the at least one processor cause the electronic device to encode the pixel space noisy input image into a latent space noisy image.

17. The non-transitory machine readable medium of claim 16, wherein the instructions that when executed by the at least one processor cause the electronic device to generate the output based on the processing of the at least one input image using the encoder model comprise instructions that when executed by the at least one processor cause the electronic device to divide the latent space noisy image into latent space noisy patches, wherein each one of the latent space noisy patches has neighboring patches information.

18. The non-transitory machine readable medium of claim 17, wherein the instructions that when executed by the at least one processor cause the electronic device to generate, using the diffusion model and based on the output, the at least one image in the latent space comprise instructions that when executed by the at least one processor cause the electronic device to:
denoise the latent space noisy patches using the diffusion model; and
reassemble the denoised latent space noisy patches into a denoised latent space image.

19. The non-transitory machine readable medium of claim 18, wherein the instructions that when executed by the at least one processor cause the electronic device to output the final image result based on the at least one image in the latent space comprise instructions that when executed by the at least one processor cause the electronic device to:
decode, using a decoder model, the denoised latent space image into a pixel space denoised image; and
output the pixel space denoised image as the final image result.

20. The non-transitory machine readable medium of claim 15, wherein:
the at least one input image includes at least one ground truth latent space image;
the encoder model is a multi-level encoder model;
the instructions that when executed by the at least one processor cause the electronic device to generate the output based on the processing of the at least one input image using the encoder model comprise instructions that when executed by the at least one processor cause the electronic device to create, using the multi-level encoder model, semantic code based on the at least one ground truth latent space image; and
the instructions that when executed by the at least one processor cause the electronic device to generate, using the diffusion model and based on the output, the at least one image in the latent space comprise instructions that when executed by the at least one processor cause the electronic device to:
input, into the diffusion model, the semantic code and gaussian noise; and
generate, using the diffusion model and based on the semantic code and the gaussian noise, the at least one image in the latent space.
